(19) United States
(12) Patent Application Publication
(10) Pub. No.: US 2006/0249211 A1
(43) Pub. Date: Nov. 9, 2006

(54) Actuator and actuator driven control device

(76) Inventors: John Edwin Tooke, Norwich (GB); Randolph Peter Lofthouse, Dereham (GB)

Correspondence Address: Jovan N. Jovanovic;The Watson Intellectual Property Group, PLC, Suite 200, 3133 Highland Drive, Hudsonville, MI, 49426, US

(21) Appl. No.: 11/338,415

(22) Filed: Jan. 24, 2006

Related U.S. Application Data
(63) Continuation of application No. PCT/GB03/05018, filed on Nov. 26, 2003.

(30) Foreign Application Priority Data
Jul. 24, 2003 (GB) 0317330.9

(51) Int. Cl. F16K 11/22

(52) U.S. Cl. 137/883

(57) ABSTRACT

An actuator mechanism comprising a bimetal element secured at one end and having a heating element mounted thereon, the bimetal element being deflectable by energising the heating element to effect thermal transfer to the bimetal element, the degree of deflection being related substantially to the power applied to energise the heating element, the deflection causing an actuator armature to move along a linear path against a biasing means adapted to return the armature to its non-deflected position. The bimetal element includes a deflector limb adapted to engage the actuator armature to effect movement thereof. The deflector limb is or includes a compensator limb for compensating for the effects of ambient temperature fluctuation. Heating element, the deflection causing an actuator armature to move along a linear path against a biasing means adapted to return the armature to its non-deflected position.

### Cross Reference to Related Application

This application is a continuation of PCT/GB2003/005018 filed on Nov. 26, 2003, which claims priority from GB application No. 0317330.9 filed Jul. 24, 2003, the entire specification of each is incorporated herein by reference.

### FIELD OF THE INVENTION

The invention relates to an actuator suitable for coupling to a mechanically driven control device, including, for example a shut-off or isolating valve.

The present invention further relates to an actuator mechanism for use in regulator devices, for example, actuator mechanisms for energy regulators including those used for controlling the supply of electrical energy to electrical loads such as domestic cooker hotplates, grills and ovens. The actuator mechanism is adapted particularly for position control and actuation of valve mechanisms, including those having a failsafe feature.

The present invention yet further relates to the flow control of fluids and particularly to gas flow control where flow is metered or variable flow control is required. The invention most particularly relates to the flow control of hazardous or combustible fluids and an exemplary use is flow control for industrial and domestic gas applications including heating boilers, gas fires and cookers.

In an exemplary arrangement, the invention relates to the provision of an electro-mechanically or piezo-electrically actuable gas valve having at least one proportionally and/or infinitely variable output.

In the description that follows, the actuator mechanism of the invention is described with respect to a “gas valve”, however, no limitation should be taken or inferred to any specific fluid or gas or to any specific use of the invention from the context in which this convenient name is used.

The term “energy regulator” is normally is directed to control devices having switched contacts operably connected into an electrical circuit between an energy source and a load to selectively interrupt or allow current flow to the load. The term is also directed to control devices having triggerable switching devices adapted to control or regulate the flow of current to a load. Also included within the meaning of the above term are such regulators commonly referred to as thermostats, rheostats and potentiometers, for example.

The invention however is not limited to energy regulators of the traditional kind where a primary control parameter such as temperature is used to influence the source causing variation in said parameter, for example, the flow of electrical current through a load or the rate of flow of gas through a valve to a burner head. Also considered within the scope of the invention are such devices which, while driven by a primary control parameter, influence or regulate either the source causing variation in an auxiliary parameter or the auxiliary parameter itself.

### BACKGROUND OF THE INVENTION

It has long been common to utilise temperature-dependent deflection of a bimetal element to fulfil a regulating function in domestic cookers, for example. The bimetal element is heated by a heating element in intimate contact with an active leg of the bimetal element which is housed within the regulator, specifically for that purpose. Typically, the deflection is used to actuate a switch mechanism to open and close electrical contacts for the supply of power to the load. Where the regulator is incorporated in a front mounted user control panel, for example, the setting at which the bimetal strip actuates the switch mechanism is determined by a rotary cam arrangement. However, in the description that follows, the rotary cam arrangement is obviated.

It is also known to incorporate a compensation element to compensate for variation in ambient temperature so that deflection of the bimetal strip is more accurately dependent on the temperature of the heating element which heats the bimetal strip.

In the established prior art, the heating element is normally energised through the control device from the same source as that used to power the load, that is, the mains electrical supply. Thus, when the load is energised the heating element begins heating the active leg of the bimetal element. When the temperature-dependent deflection occurs, the power supply to the load and to the heating element is broken and the heating element cools. When the active leg of the bimetal element returns to its normal (cold) position, the switching mechanism re-establishes (makes) the circuit bringing the power supply back into connection with the load and the heater. The heater is energised again and so the cycle recommences.

The invention is directed to overcoming some of the complexities and disadvantages associated with existing regulators and is further directed to realising an actuator mechanism suitable for driving control or regulator devices, preferably to provide proportional and/or infinitely variable control using standard electronic control circuitry and instrumentation.

It is also known to regulate gas flow, by using, for example, a spring-loaded solenoid device to open and close a gas valve. However, using existing solenoids under variable temperature conditions, such as those found in industrial and domestic cooker and boiler systems, consistent operation over the lifetime of the appliance is difficult to achieve. Known solutions are often complex and expensive.

To provide a relatively inexpensive, robust solenoid actuated valve capable of withstanding such operational conditions may limit the construction to a simple ON/OFF valve and accurate intermediate or “OFF assured” control may not be achievable. For gas valves (and other control devices), it is of critical importance that the OFF state results in zero gas flow or such minimal flow as to pass all regulatory authority tests. It is also important to ensure that the OFF state corresponds to a power off state, that is, either where the appliance is off or in the event of a power failure.

Furthermore, conventional solenoid-based controllers have well-appreciated operational limitations including, for example, temperature limits. In commercial and domestic ovens (cookers), there is a requirement for controllers to be able to operate at temperatures of 150 C. Additionally, solenoids can be both electrically and physically noisy. Where a solenoid is being cycled at 50 Hz mains power, unwanted vibrations may be set up in the panels or body of the appliance. It is also known that solenoids can be attitude sensitive so that positioning or orientation of the device is limited. This is particularly so at high temperatures.

Alternative gas valves are also considered in the detailed description that follows and it will be appreciated by the skilled addressee that the technical field of gas valves is populated with manual, electro-mechanical and pneumatic devices. More recently, the demand for electronically controlled gas valves has lead to the development of many alternative arrangements for controlling valves.

For cost reasons and to adhere to regulations, in particular those relating to energy efficiency, it is desirable to make use of simple parts with low energy consumption. It is for this reason, together with the low failure rate of bimetal elements and mounted ceramic heating elements, that a bimetal electro-mechanical actuator is considered despite the relatively small movement available. It will be appreciated that the deflection force available is significantly greater than the actuator force available from alternative high reliability sources, including piezo-electric benders, for example. The above statement does not, however, preclude the use of piezo-electric actuating devices or mechanisms in the present invention. In certain arrangements of the invention, as detailed below, piezo-electric actuators are used with or as an alternative to bimetal actuators.

The invention is therefore directed to overcoming some of the established disadvantages associated with fluid flow valves, particularly realising a gas valve which is infinitely variable within a range and is adapted for use with standard electronic control circuitry and instrumentation.

It is an object of the present invention to seek to alleviate known disadvantages or limitations of prior art control devices and to provide an electrically controllable actuator mechanism having a minimal parts count, which facilitates production line assembly, has low manufacturing tolerances, has high reliability and facilitates direct action control.

It is a further object of the invention to provide an electrically controllable actuator mechanism which can be interfaced with standard control or regulator devices, including valves, to effect proportional and/or infinitely variable output control.

It is a particular object of the present invention to provide a fluid flow valve or safety shut off device, including a gas flow regulating device which may be used, for example, with cooker hobs and/or ovens to control accurately the flow of gas to the oven cavity or hob outlet irrespective of the temperature in which the apparatus is operating.

It is an additional object of the invention to provide an infinitely variable valve mechanism which is easily adaptable for single and multi-port valve use and which facilitates the use of standard electronic interfaces and control instrumentation.

It is a particular object of the invention to provide a method opening a valve or valve seal using minimal operational force.

### SUMMARY OF THE INVENTION

In its primary aspect, the present invention provides a method of opening a valve seal using minimal operational force, the method comprising:

forming a seal using a cantilevered blade, thereby defining a leading or distal edge;

engaging the distal edge to “peel” back a portion of the blade to break an established seal; and thereafter

moving the blade in accordance with required flow control parameters.

In its broadest physical aspect, the invention provides an electromechanical or piezo-electric actuator suitable for coupling to a mechanically driven control device or regulator, whereby output motion generated by the electrically operated actuator exercises a control function, the movement being provided by the deflection of a bimetal or piezo-electric element.

The present invention also provides a multi-port valve having an integrally formed valve body comprising a plurality of through-flow orifices each being provided with independently actuable valve opening means, each of said means comprising an actuator which is operably connected to an orifice sealing element in such a way as to lift a free edge of the sealing element to break an established seal.

Convinently, the actuator includes a bimetal element which is deflectable by energising a heating element attached thereto.

Optionally, the actuator comprises a piezo-electric element which is connected to and deflectable by an energising circuit.

Ideally, the flow characteristic of each valve of the multi-port valve need not be the same.

In one arrangement, a two-port valve is provided with a pair of orifice sealing elements both being operably coupled to a single valve opening actuator.

In a preferred arrangement of multi-port valve, the valve body comprises at least two castings, the first casting comprising an inlet manifold defining a series of side-by-side through-flow orifices connecting a single inlet port to the multiple outlet ports and the second casting comprising a lid to define sealingly said inlet manifold.

Preferably, the first casting includes anchor points for the valve opening means.

This arrangement facilitates the ready construction of a multi-port valve in a series of layers as might be used on an assembly line.

In a further aspect, the present invention provides a fluid flow valve comprising:
an actuator housing;
an actuator element mounted within the housing and adapted to deflect when energised;
an actuator armature operably comprising a valve opening means; and
a through-flow orifice defined between a supply inlet port and an outlet port, all formed within a second housing attached to the actuator housing, adapted to receive the armature driven valve opening means

in which the valve opening means engages the through-flow orifice to effect a releasable seal.

Conveniently, the actuator armature is coupled to a valve mechanism having a sealing element normally held in sealing connection to the through-flow orifice.

In one arrangement, the fluid valve comprises a butterfly valve having a shaft about which the butterfly valve element rotates, the shaft including a gear means adapted to engage, and operably rotate with the movement of, the actuator armature.

In another arrangement, the fluid valve orifice includes a valve seat which is operably engaged by a valve member attached (directly or indirectly) to the actuator armature so that, when the actuator element is deflected, the valve member lifts from the valve seat to allow fluid flow through the orifice.

In a further arrangement, the fluid valve orifice includes a sealing element which is operably attached (directly or indirectly) to the actuator armature so that, when the actuator element is deflected, a free edge of the sealing means is lifted to break an established seal.

In a yet further aspect of the present invention, there is provided an actuator driven valve mechanism, suitable for use with fluid valves of the type used for controlling the fluid flow of combustible and/or hazardous liquid and gaseous media, having a supply inlet port and at least one outlet port and defining therebetween a through-flow orifice, the valve mechanism comprising a sealing element, the element being held in sealing connection with the orifice by a biasing means against which a valve opening means acts, the valve opening means comprising an actuator armature which is operably connected to the sealing element in such a way as to lift a free edge of the sealing element to break an established seal.

Conveniently, the biasing means acts directly on the actuator armature, the movement of which is governed by the deflection of an actuator element which is deflectable when energised.

Preferably, the sealing means comprises a flexible blade held in cantilever arrangement and resting across the orifice.

Conveniently, the actuator armature operably “peels back” the sealing element from engagement with the orifice to break the established seal.

This arrangement maximises the deflection characteristic of the bimetal element of the actuator to break the seal against the pressure differential between the supply pressure (for example) and the low-pressure side by peeling back the leading or distal edge of the sealing element.

Advantageously, the sealing means is in the form of a thin blade adapted to form a gas-tight seal against the orifice under the force of a biasing means. The gas-tight seal may be further facilitated by the presence of a positive pressure differential.

The blade is preferably metal and ideally has a finish which is sufficiently smooth to form at least a substantially gas-tight seal. Optionally, a plastics material layer or film may be applied to one side of the blade to provide the requisite finish.

Most preferably, the blade comprises a first metal blade and a second plastics material blade having a finish which assures a gas-tight seal.

The blade arrangement is such that the plastics material blade may be a thin film.

Alternatively, the blade comprises a plastics material onto which there is applied, conveniently by sputtering, a metal layer which could close the seal sufficiently to prevent failure of the valve in case of fire.

In preferred construction, a biasing means acts directly on the blade, distorting the blade so that a concave shape is imparted on the blade which “dips” into the orifice of the valve. This arrangement assures a greater sealing area around the mouth of the orifice, avoiding the necessity to register positively pre-formed shapes.

Conveniently, the orifice has a sealing O-ring or similar distortable sealing element around the mouth thereof.

In the exemplary construction of the present invention, the plastics material blade is separate from the metal blade so that the plastics material blade may be further drawn (“dipped”) into the orifice creating a high quality seal of greater sealing contact area than mere face-to-face contact.

An intervening plastics material leaf between the blade and the orifice of the passageway provides a cheap, consistent, polished surface which obviates an expensive polished metal-to-metal interface to realise the seal. The use of a plastics coated metal blade to seal against an O-ring addresses certain perceived disadvantages but does not provide the advantages envisaged using the intervening leaf which can undergo a concave deformation to provide an enhanced seal, notionally independent of the deformation of the main blade.

While the blade may be secured at a point remote from the through-flow orifice, it will be appreciated by the skilled addressee that the peeling action of the sealing element blade defines a pivoting locus which moves across the blade in a region corresponding to the orifice moving from the free edge of the blade towards the securing axis remote from the orifice.

In the preferred construction, where the biasing means acts upon the blade, the true pivot axis of the blade is not where it is secured but the point where the blade is constrained by the biasing means which may comprise a leaf spring. The biasing spring acts on a point, if not coaxial at least coincident with the gas flow channel or orifice. Closer analysis reveals that the pivot axis of the blade moves across the orifice as the blade “peels off” the orifice or the O-ring seal.

The blade is constructed to form a gas-tight seal when a sealing or top pressure in the range of 10 to 70 mBar is applied thereto. The range given is not intended to imply that blade designs for other pressures or pressure ranges cannot be achieved.

Preferably, the actuator armature is disposed in operable connection to the leading edge of the or each blade so that on powered deflection of the actuator element, the leading edge is peeled back from sealing connection with the orifice, thereby breaking the seal. Once the seal is broken the only force against which the armature has to work is that of the biasing means.

In another aspect, the present invention provides an energy regulator comprising:
an actuator housing;
an actuator element mounted within the housing and adapted to deflect when energised;
an actuator armature operable to actuate a switch or control means for an auxiliary control parameter; and
a switch or control means mounted within a second housing attached to the actuator housing and adapted to receive the actuator armature.

In one arrangement, the control means comprises a rheostat or potentiometer for regulating said auxiliary control parameter.

In an adapted construction, the switch is mounted within the actuator housing.

The term “auxiliary” in the phrase “auxiliary control parameter” is intended to indicate that the parameter controlled is independent of the temperature causing the bimetal element to deflect or independent of the power used to energise the heating element of the actuator. It will be appreciated however that the power applied to the heating element may be controlled as a feedback function of the auxiliary control parameter to effect control thereof.

Conveniently, armature guides are provided in the or each housing to constrain the armature movement along a linear path.

Preferably, the or each guide includes a sealing means to ensure the actuating energising, electrical heating, switching or control means function is isolated from the surrounding atmosphere. Where the actuator is operating in an atmosphere where combustible gas is present or a gas valve is in direct connection with the actuator, it is particularly important to ensure uncontrolled combustion does not occur. Low voltage (24V) energisation of the heating element of a bimetal element is optionally used instead of mains voltage and/or the actuator housing can be made sufficiently robust to withstand combustion of gas which may, over time, accumulated therein.

The armature moves linearly with respect to the housing by an amount which is representative and preferably proportional to the increase in power applied to energise the heating element.

More particularly, the present invention provides an actuator mechanism comprising a bimetal element having a heating element mounted thereon, the bimetal element being deflectable by energising the heating element to effect thermal transfer to the bimetal element, the degree of deflection being related substantially to the power applied to energise the heating element, the deflection causing an actuator armature to move along a linear path against a biasing means adapted to return the armature to its non-deflected position.

Advantageously, the bimetal element comprises an active portion and a compensator portion for compensating for the effects of ambient temperature fluctuation.

Conveniently, the active portion comprises a deflector limb adapted to engage the actuator armature to effect movement thereof.

It will be appreciated by the skilled addressee that the above arrangement alleviates or at least partially overcomes the known drawbacks of a majority of solenoid actuators.

Bimetal element deflection is inherently more reliable than solenoid activation, involves less moving parts and is considerably less expensive to implement. Furthermore, although the range of deflection is of a similar order to the deflection available from a piezo-electric bender, for example, the deflection force available from a bimetal element is significantly greater.

In one construction of actuator mechanism, the bimetal element comprises an active portion responsive to the heating element mounted thereon and a compensator portion for compensating for the effects of ambient temperature fluctuation, wherein the active and compensator portions are formed of the same piece of bimetal and the bimetal element is secured at one end within an actuator housing.

Using this form of construction, ambient compensation is automatically achieved whilst substantially eliminating deflection constant variations.

In a preferred embodiment of the actuator mechanism, the active portion includes an adjustment means. The adjustment means facilitates the matching of the movement of the actuator armature to the movement required to utilise the range of the controller, regulator or valve to which the actuator is attached.

The design therefore has the advantages of giving optimum compensation, elimination of bimetal constant variation problems and also enables a compact or low profile design of actuator and/or associated control to be considered.

Conveniently, the active portion of the bimetal element and the compensator portion are integral, for example, formed by splitting a bimetal strip lengthways from one end along a part of its length. Optionally, the bimetal strip is secured at its split end.

Preferably, the bimetal element is stamped or laser-cut and formed into the required three-dimensional shape.

Alternatively, the present invention provides an actuator mechanism comprising a piezo-electric element having an energising circuit connected thereto, the piezo-electric element being deflectable by electrically stimulating the piezo-ceramic material of the element, the degree of deflection being related substantially to the power applied to energise the element, the deflection causing an actuator armature to move along a defined path against a biasing means adapted to return the armature to its non-deflected position.

Conveniently, the piezo-electric element comprises a deflector limb adapted to engage the actuator armature to effect movement thereof.

It will be appreciated by the skilled addressee that the above alternative arrangement addresses or at least partially obviates the known drawbacks of a majority of solenoid actuators.

The electrical energisation of a piezo-electric actuator or “bender” provides deflection characteristics inherently more reliable than solenoid activation, involves less moving parts and is considerably more electrically efficient. Furthermore, although the range of deflection is of a similar order to the deflection available from a bimetal actuator, for example, the response time available from a piezo-electric element is significantly faster.

Advantageously, the energising circuit includes control circuitry adapted to compensate for effects of ambient temperature fluctuation and includes set-point adjustment means.

Conveniently, the adjustment means facilitates the matching of the movement of the actuator armature to the movement required to utilise the range of a controller, regulator or valve to which the actuator is attached.

To increase the response time of a deflectable actuator armature, a pair of piezo-electric actuator elements may be attached thereto to deflect the actuator armature in opposite directions. Alternatively, piezo-electric actuator element may be connected to an energising circuit capable of powering the element to defect the element in opposite senses.

It will be appreciated that a reduction in component count may be anticipated for standard control devices and particularly for multi-function or multi-circuit devices.

### BRIEF DESCRIPTION OF THE DRAWINGS

The invention will now be described more particularly with reference to the accompanying drawings which show, by way of example only, several embodiments of actuator, together with arrangements of control device utilising the actuator in accordance with the invention. In the drawings:

FIG. 1a is a perspective elevation of a construction of bimetal element having a heating element on the active portion of limb thereof;

FIG. 2a is a first construction of actuator adapted to urge an armature downwardly upon deflection of the bimetal element;

FIG. 2b is a second construction of actuator adapted to urge an armature upwardly upon deflection of the bimetal element;

FIG. 3a is a schematic representation of an armature operating an electrical switch;

FIG. 3b is a schematic representation of an armature operating a potentiometer and switch;

FIGS. 4a to 4c are cross-sectional side elevations of a first arrangement of actuator driven valve mechanism;

FIG. 5a is a perspective elevation of a gas outlet pipe, defining a through-flow orifice, and an over-orifice portion of a sealing element;

FIG. 5b is a perspective elevation, similar to that of FIG. 5a, in which a leading edge of the sealing element is peeled back from one side of the orifice;

FIG. 5c is a representation of the curved surface area of the aperture opened to the through-body orifice when the sealing element is peeled back;

FIGS. 6a and 6b are plan views of sample shapes of the sealing element blade for use with the present invention;

FIGS. 7a to 7d are side elevations of the valve orifice and a blade having a biasing spring associated therewith for biasing the blade towards sealing engagement with the through-flow orifice and illustrating the progressive action of the actuator on the leading or distal edge of the blade;

FIG. 8a is a detailed perspective view of a first actuator element adapted for use with the peeling actuator;

FIGS. 8b(i) and 8b(ii) are a side elevation and plan view of a second bimetal element adapted for use with the peeling actuator;

FIGS. 8c(i) and 8c(ii) are a side elevation and plan view of a third actautor element adapted for use with the peeling actuator;

FIGS. 8d(i) to 8d(iii) are a side elevation, plan view and perspective view of a fourth actuator element adapted for use with the peeling actuator;

FIGS. 9a to 9c are elevations of a valve assembly in accordance with the invention; and

FIG. 10 is a detailed sectional perspective view of a multi-port valve assembly.

### DETAILED DESCRIPTION OF THE INVENTION

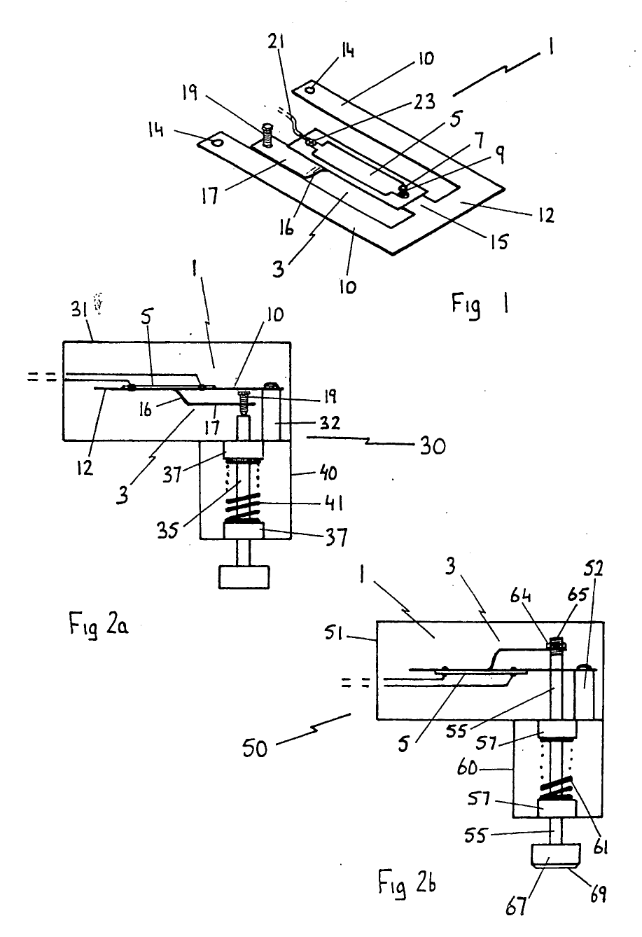

Referring to the drawings and initially to FIG. 1, a bimetal element is denoted generally by reference numeral 1. The bimetal element 1 comprises an active portion or limb 3 to which a ceramic substrate thick film heater assembly 5 is secured by means of an eyelet 7 and a surrounding coil spring 9. A compensator portion 10 extends around the periphery of the active limb 3 and is contiguous therewith. In other words, the primary limb and compensator portion constitute separate portions of a single piece of bimetal, joined by a base region 12. The compensator portion comprises two limbs 10 which are provided with securing holes 14 to fix the bimetal element to a secure mounting.

The active limb 3 comprises a root portion 15 in contact with the substrate heater 5, an oblique portion 16 extending away from the substrate heater and a distal portion 17 spaced apart from the substrate heater. The fact that only the root portion 15 is in direct contact with the substrate heater 5 maximises the differential deflection of the active limb 3 for a unit temperature change.

Calibration of the bimetal element is effected by means of a calibration screw 19 provided at the distal portion 17 of the active limb 3. In use, the calibration screw 19 is used in the initial set-up to calibrate the deflection action of the bimetal element 1 with respect to the actuator application.

It will readily be appreciated that the temperature change as a result of electrically energising the substrate heater 5 will excite the root portion 15 of the active limb 3. The lever ratio will result in the active limb and the calibration screw 19 together acting as a deflecting limb to urge a follower mechanism, switch, plunger, armature or other such mechanism in a direction dictated by said deflection. It will also be apparent that the compensator portion 10 will compensate for ambient temperature variation.

The active and compensator limbs 3,10 are formed from a single piece of bimetal either by stamping or laser cutting, for example. In the illustrated construction, the base region 12 which forms the structural backbone of the bimetal element is unrestrained to allow the compensator limbs 10 to act.

The formation of the active and compensator limbs 3,10 from a single piece of bimetal substantially ensures elimination of deflection constant variations which would result if the two portions were fabricated separately.

Electrical connection is made to the substrate heater 5 by way of flexible wire 21 so as not to interfere with the bimetal movement. Alternatively, a cupronickel or nichrome tape, or a tape of similar material, may be used. The connection is made via a rivet connector 23. In order to allow the substrate heater 5 and active limb 3 to move freely without unduly stressing the electrical connections, the eyelet 7 and coil spring 9 attachment facilitates flexible electrical connection of one side of the heater element 5 through the bimetal element for connection at the unmoving anchor point. The other end of the heating element 5 is free, allowing clear access thereto without risking a short-circuit to the bimetal. The connection is usually realised using flexible wire or metal tape 21.

The resistor track of the ceramic substrate thick film heater 5 is electrically connected to a conductor pad. The connection 21 is welded to the conductor pad usually by ultrasonic welding. This weld is capable of operating at an ambient temperature in excess of 380 C without oxidation or deterioration with age.

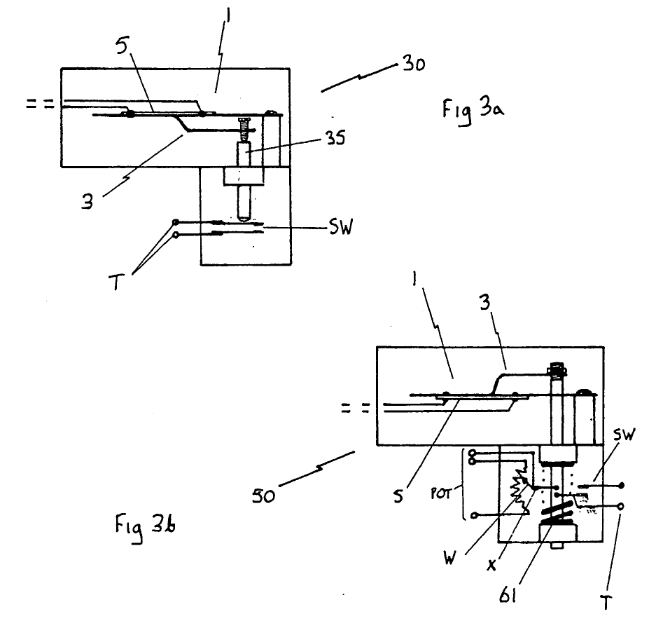

Referring now to FIG. 2a, an electromechanical actuator assembly 30 is shown. The assembly 30 comprises a housing 31 within which there is provided a mounting column 32 for securing a bimetal element 1 having a heating element 5 on the active limb 3 thereof. The active limb 3 constitutes the deflecting limb of the actuator. An actuator armature 35 is constrained within guide members 37 provided in a second housing 40 within which a biasing spring 41 is disposed to provide a spring force to return the armature 35 to the un-deflected position. The guide members 37 additionally provide fluid sealing means to prevent, for example, combustible gas entering the actuator housing 31 through armature passage holes in the housings 31,40.

When the heating element 5 is energised, the active limb 3 deflects so that the calibration screw 19, carried by the distal portion 17 of the bimetal active limb 3 and abutting the upper end of the armature 35, urges the armature downwardly (in this orientation). The amount of deflection is consistent with the change in temperature of the bimetal element which in turn is related to the energising power applied to the heating element. Accordingly, proportional position control, or at least infinitely variable control within a range, is realised.

It will be readily appreciated that the armature 35 may be coupled, for example to a switch, potentiometer, gas valve or the like. In the construction illustrated in FIG. 2a, the un-deflected armature position, as connected to a valve plunger, is representative of a closed valve and the deflected armature position represents an open valve position. The calibration screw 19 is used at set-up to ensure the un-deflected position corresponds exactly to the closed valve (OFF) position.

FIG. 2b illustrates a second actuator assembly 50, having a housing 51 within which there is provided a mounting column 52 for securing a bimetal element 1, as before. In this construction the position of the bimetal element 1 is reversed so that the active limb 3 is arranged to deflect upwardly (in this orientation). Again, the actuator armature 55 is constrained within guide members 57, located in a second housing 60 within which the biasing spring 61 is disposed.

In this arrangement, the calibration screw 19 is substituted by a threaded collar or nut 64 which pre-sets the position of the distal portion 17 of the deflecting limb 3 along a correspondingly threaded portion 65 of the armature 55.

This particular construction of actuator, while of equal utility to the first, with respect to switching and position control, is adapted for direct use with a valve mechanism in which the armature head 67 is so sized and shaped to form a valve sealing member 69 which operably seals against a valve seat (not shown). Accordingly, as the bimetal element 1 deflects, the valve sealing member 69 is withdrawn from the valve seat to allow fluid to flow. An increase in the amount of deflection results in further fluid flow. The amount of deflection or movement of the armature 55 as against the fluid flow available may be correlated to provide proportional fluid control.

It will be seen that in the construction of both actuator assemblies 30,50, the biasing springs 41,61 provide a failsafe mode.

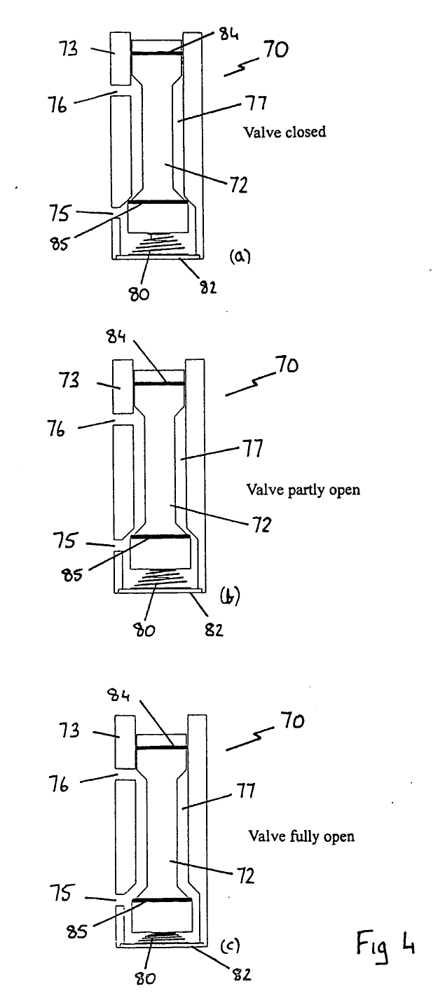

FIGS. 3a and 3b show electro-mechanical actuator assemblies substantially identical to these illustrated in FIGS. 2a and 2b and are denoted by the same reference numerals 30.50, respectively. The arrangement shown in FIG. 3a is an actuator assembly 30 in which the armature 35 is deflected as before but to “make”, a switch SW. Switch terminals T are provided either as spade type contacts on the assembly housing or as lead outs. The switch SW is advantageously an over-centre spring which when deflected reaches a point where a snap-action occurs “making” the circuit. As the bimetal deflection decreases as the temperature on the active limb 3 drops, the snap-action of the switch spring ensures the armature returns to its un-deflected position. The arrangement shown in FIG. 3b illustrates how the same functions might be applied to the second actuator assembly 50. As described with respect to FIG. 2b, the deflection of the bimetal element 1 is reversed so that it is directly upwardly (in the illustrated orientation). Ideally, the armature 55 is constrained within the guides 57 and the biasing spring 61 is provided to ensure the armature returns to its un-deflected position. In this case the switch SW need not be an over-centre spring type switch. Again, switch terminals T may be of the spade type on the assembly housing or lead outs. Similarly, potentiometer terminals POT may be provided as housing mounted spade type contacts or as lead outs. The wiper contact W is mounted to a lever arm which pivots around an axis X. The opposite end of the lever arm is attached to the armature and moves upon deflection thereof. Ideally, the armature is a low friction plastics material through which pins to move the lever arm and/or carry the moveable switch contact are secured.

The arrangement described is applicable to any system where regulation of gas flow is required. In particular to any system where regulation of gas flow is required in a confined space, under high operational temperatures and at low cost.

The arrangement illustrated is particularly advantageous because it allows the flow of gas to be accurately controlled by varying the position of the armature that actuates a gas controlling valve, while exhibiting the following traits:
is not susceptible to power surges and transient signal spikes;
ease of installation behind the cooker control panel and/or the oven cavity;
facilitates remote positioning away from cooker panel;
significantly less expensive than most known alternatives with high reliability;
performance characteristics well-established;
provides electronically controlled fluid flow valve; and
automatic failsafe operation.

The actuator movement is not limited to the vertical, as described above, or to direct acting mechanisms. Other options include radial, ratchet, and pivoted actuator movement.

Although it is proposed to use the arrangement illustrated to open and close a valve the arrangement could also be used in applications where a movement is required to close and then open a valve and/or regulate the opening and closing of a valve within a control. The arrangement may also be combined with feedback to provide more intelligent controls.

It will however be appreciated by the skilled addressee that the bimetal actuator element illustrated in FIGS. 1 to 3b may be substituted by a piezo-electric actuator. Similarly, piezo-electric devices may be adapted to interact with existing and modified energy regulators and similar control devices. Features such as calibration, ambient temperature compensation, improved response times and other operating characteristic are controlled via the energising circuit connected to the piezo-electric element. A control circuit is used to regulate the energising power to the actuator element and either directly or via a feedback circuit regulate the degree of deflection to provide proportional control. The term “actuator element” or “actuator” as used herein should be taken to mean a bimetal or a piezo-electric element or actuator unless the description specifically dictates otherwise.

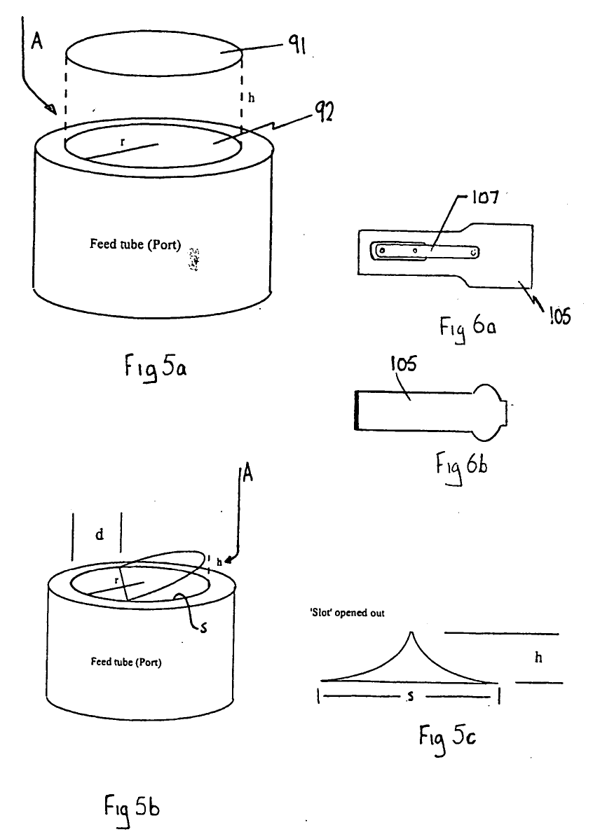

Referring now to FIGS. 4a to 4c, a valve mechanism 70 is illustrated. It will be appreciated by the skilled addressee that the valve 72.illustrated may be connected (directly or indirectly) to an actuator armature. In this preferred construction, the actuator armature is formed as the valve actuator 72 itself. The valve mechanism comprises a substantially cylindrical body 73 in which the valve actuator 72 is adapted to move along a co-axial path. The body defines an inlet port 75 and an outlet port 76 connected by a through-body passage 77. In FIG. 4a, the actuator is not energised and the valve is closed by the action of a spring 80 mounted on a gas-tight cover 82 adapted to screw into the base of the valve body 73. An O-ring 84 is mounted on the actuator 72 adjacent the inlet port 75 to prevent gas or any other fluid entering the through-body passage 77. A similar O-ring 85 is provided on the opposite side of the outlet port 76 to prevent gas from entering the actuator assembly housing (not shown). As the actuator element is energised, for example where a bimetal element 1 is heated by the heating element, the active limb 3 of the actuator armature deflects against the action of the spring 80 and gradually opens the valve, as illustrated in FIG. 4b. When the actuator element is fully energised (or for a bimetal element, there is sufficient thermal transfer from the substrate heater to the active limb to fully deflect the active limb 3), the valve will open fully, as shown in FIG. 4c.

When the actuator element is no longer energised, the spring 80 forces the valve actuator 72 back to its closed position and together with the O-rings 84.85 assures the OFF state.

In the construction of gas valves that follow, particular emphasis is placed on the stiffness characteristics of the sealing means (blade). This emphasis is to explore the benefits derived from thinner (and more sensitive) bimetal actuators and valve sealing means. It should be appreciated that existing bimetal elements have sufficient deflecting force to open valves such as those described below when utilising stiffer blades and using the peeling techniques detailed hereinafter. The results of this analysis may also be applied to the construction of piezo-electric actuators.

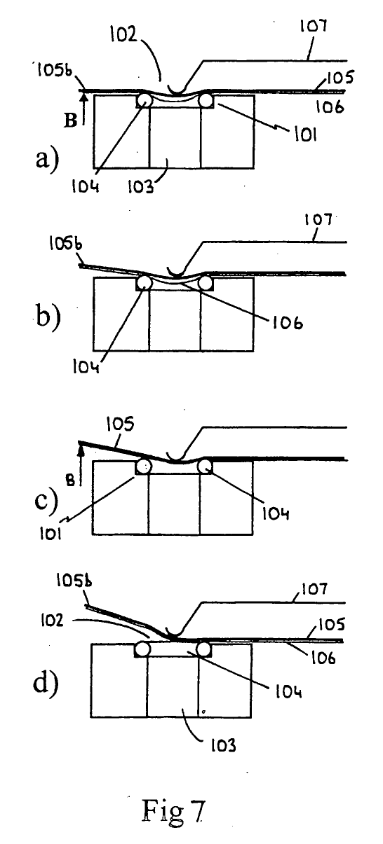

Referring now to FIG. 5a, it is appreciated that to provide sealing against gas flow in the general direction of arrows A, a sealing element 91 of a required rigidity will be required. It is also appreciated that the amount by which the sealing element 91 needs to be moved, and thus the actuator movement required, is dependent on the need for laminar or smooth flow and the diameter D of the orifice 92 being sealed. It is generally accepted that to achieve smooth flow, the distance of the sealing surface from the orifice must be no less than 25% of the effective flow diameter D of the orifice. This distance represents the height dimension h of the curved surface area of a cylinder through which gas can flow unrestricted and is equivalent to the maximum flow area represented by the through-flow passageway.
Area of orifice=Area of curved surface of cylinder
πr²=2πrh∴r=2h
h=D/4 (0.25 D)

As stated in the preamble of the specification, gas control valves are normally specified to present minimal attenuation to the available gas flow when fully open. This means that where possible there should be a minimal pressure drop across the valve when the flow rate is at maximum. To achieve a pressure drop of no greater than say 1 mBar, the valve orifice should be roughly the same diameter as the supply pipe to the valve or valve assembly. In the example presented, the incoming supply pipe has an internal diameter of 4 mm, so that the valve seal clearance must be at least 1 mm. By selecting an appropriate shape and configuration of actuator, such as that described herein, the required movement can be easily achieved.

For many reasons it is advantageous to position the valve seat on the top pressure side of a valve housing. In the available prior art, however, there is a preponderance of devices which close the sealing element against the supply or top pressure. Often, to assure closure or to ensure the valve will close in an emergency such as fire or where power becomes unavailable, these devices require complex, and therefore expensive, arrangements to meet national and regional laws and regulations. It will be apparent that the top pressure can itself be used to assure a seal by providing a seating force to mate the sealing element with the valve seat and to distort where necessary a deformable O-ring or similar of the valve seat.

In the description that follows, the valve sealing element comprises essentially a cantilevered blade which according to its shape utilises the top pressure effect to a greater or lesser extent. Furthermore, a closure spring may be provided to bias the sealing element towards the valve seat in the same direction as the gas flow. If a biasing spring is acting against the gas flow, it will be apparent that the force demand on the actuator will increase, thereby reducing the available actuator deflection.

Referring now to FIGS. 5b and 5c, a through-flow orifice 92 of the type represented in FIG. 5a is shown. However, in this instance, the sealing element is peeled back to define a controllable gas flow orifice. For a peeling action, the laminar condition will be defined by:
Area feed pipe=Surface area of peeled slot, Sa(s)

The opened out shape of the slot or aperture formed is represented in FIG. 5c and can be approximated as a triangle, a dual catenary or a dual inverse circle, with various degrees of (small) error. The surface area Sa can then be calculated to a first order.

For a triangle, it can be shown that
Sa(t)=rh(π−cos⁻¹((r−d)/r)) (1)
where h is the maximum height of the aperture
and d is the minor distance of peeling base chord from internal circumference of valve opening (distance of the slot cord from its parallel tangent at the point opposite the lifted edge).

For a catenary, it can be shown that
Sa(c)=2a² sin h(s/2a)−s.h₀ (2)
where a is the catenary constant for the equation h=a cosh(s/2a),
h₀ being the value of h when s=0
s is the arc length of exposed orifice, thus s=2r(π−cos⁻¹((r−d)/r))

For an inverse circle, it can be shown that
Sa(i)=s(R+h)/2−R²θ (3)
where R=(s²/4+h²)/2h and θ=cos⁻¹((R−h)/R)

Using practical values for d and h, and the general area equation πr²=Sa(s), the values for Sa(t) or Sa(c) or Sa(i) as desired may be calculated and the minimum valve port diameter can be determined for a particular pipe diameter, for example, for r=7 & d=4, s will be 28; and at h=1, a will be 90.

The stiffness of the sealing element or blade is of importance to the functioning of the valve mechanism. The sealing element or blade needs to be sufficiently flexible to allow for the “peeling action” of the preferred embodiment. As with most systems it is essential to find a balance between parameters such as stiffness and the oscillations or pressure pulses, which can result if the blade proves to be too flexible.

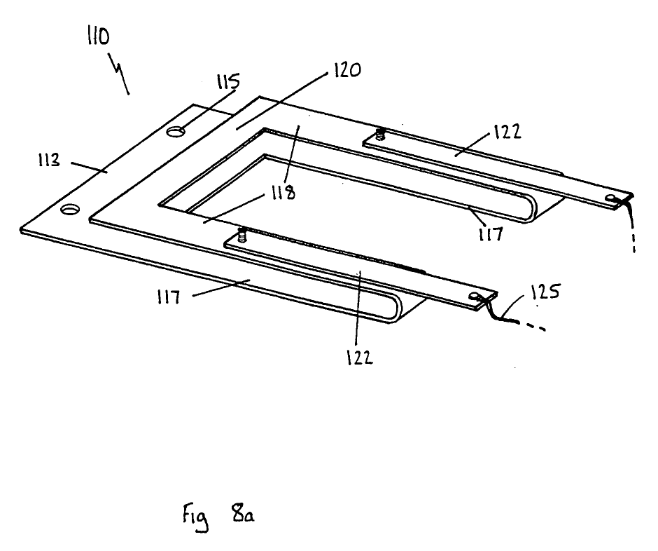

Sample shapes of the sealing element blade 105 are shown in FIGS. 6a and 6b. Variations of the illustrated shapes are also applicable to the present invention. It will be appreciated that the blades are held at one end to form a simple cantilever whereby the free or distal end of a blade is aligned with an orifice. The sealing element 105 may include an integral biasing element 107 to maintain sealing engagement with an orifice until the blade is acted upon by the actuator.

The shapes may be altered to change stiffness characteristics and may include features, such as strain gauge bridges to provide feedback to control instrumentation or substrate heaters to cause deflection of a bimetallic element on or integral with the blade, to enhance the functions of the valve.

The nature of the valve function is conveniently suited to the fabrication of the components in layers, permitting the replication of the basic construction as a multiple-output system (multi-port valve).

The above constructions and similar constructions facilitate the realisation of a proportional electronic valve that uses low-force, high movement actuators to work against a top pressure in the region of 20-200 mBar with the control of the critical opening and restriction zones to prevent sudden opening and thus uncontrolled fluctuation in flow.

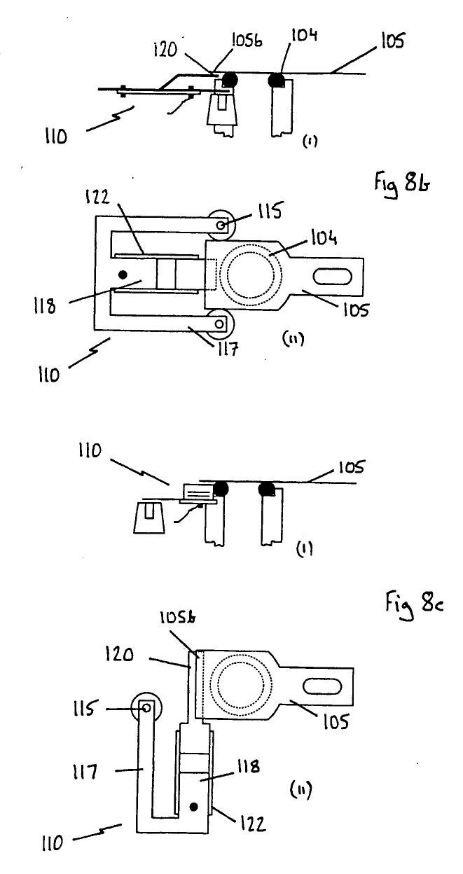

Referring now to FIGS. 7a to 7d in which there is shown a valve seat 101, comprising an orifice 102 at one end of a gas through-flow passageway 103 and an O-ring seal 104, over which there is disposed a blade 105 of the type shown in FIGS. 6a and 6b. These blades 105 are provided with a plastics material layer, particularly in the form of a thin layer of plastics film 106, which have a finish which assures a gas-tight seal when operably pressed against an O-ring seal 104. The blade 105 is urged towards sealing engagement with the orifice 102 by a biasing spring 107 which aligns with the orifice 102 and may distort the blade slightly so that it “dips” into the orifice of the valve. At the free end 105b of the blade, a lifting member or surface of the actuator urges the blade in the direction of the arrow B when the actuator is enabled, as shown in FIG. 7a. When the actuator is enabled, the free end 105b of the blade including the film 106 is lifted by the lifting surface of the actuator. As illustrated in FIG. 7b, the blade 105 and film 106 are peeled back towards the O-ring 104 until, as shown in FIG. 7c, the seal is broken and the flow of gas is facilitated. The blade and film align together at this stage as there is no pressure differential drawing the film 106 into the orifice 102 (such as can be seen in FIG. 7a). The blade 105 continues to follow a peeling path as the actuator elevates the free end 105b thereof. It will be appreciated that the point at which the biasing spring 107 abuts the blade defines the end of the peeling motion, however, the resilience or the relative stiffness of the blade 105 will ensure that the spring 107 is also carried upwards, thereby increasing the fluid flow path and consequently the rate of fluid flow. FIG. 7d shows the valve in its fully open position where the blade 105 carries the biasing spring 107 upwardly under the action of the actuator.

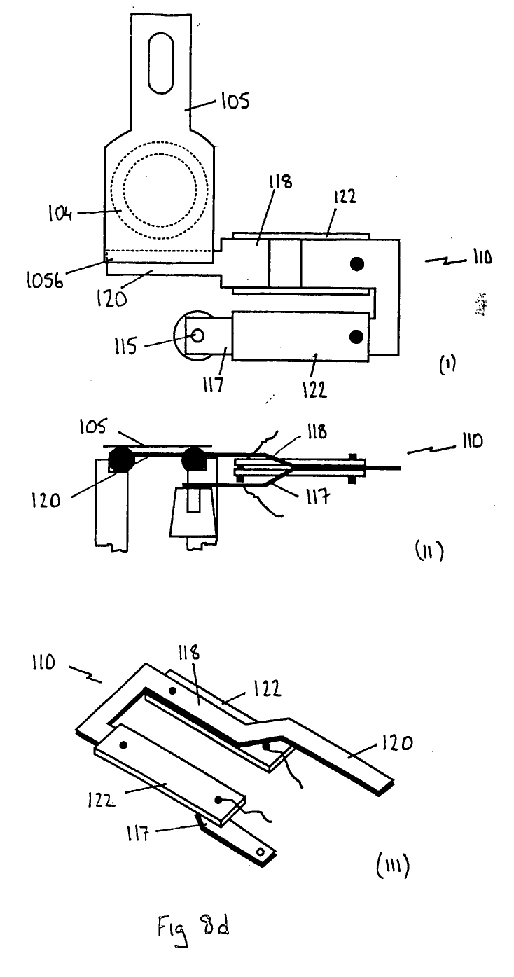

FIGS. 8a to 8d illustrate various constructions of bimetal actuator all of which are described using common numerals. A first construction of bimetal actuator 110 is shown in FIG. 8a and comprises a connector plate 113 which may be fixed to a connector block. Mounting apertures 115 are defined in the connector plate 113 for securing the plate either via the block or directly to the valve housing (not shown). A pair of compensator limbs 117 are integrally formed with the connector plate 113 and are connected via the active limbs 118 to a lifting surface 120 which operably engages the free end (105b) of the blade defining the sealing element. Ceramic heating elements 122 are applied to the active limbs. Conducting tape 125 is used to connect the free ends of the heating elements, the other terminals being connected in common through the bimetal. When the heating elements are energised, the active limbs 118 of the bimetal material causes the lifting surface 120 to deflect, carrying the free end of the blade.

FIGS. 8b(i) and 8b(ii) are illustrations of a second bimetal actuator 110 having mounting apertures 115 for securing the actuator to a valve housing. The bimetal includes compensator 117 and active limbs 118, the active limb carrying the heating element 122 as before. The lifting surface 120 is positioned to engage the leading edge 105b of the blade 105 to break an established seal against the O-ring 104 of the through-flow orifice 102.

FIGS. 8c(i) and 8c(ii) are similar illustrations to those shown in FIGS. 8b(i) and 8b(ii), however, only a single compensator limb 117 is used and the bimetal actuator 110 is presented at an angle to utilise available space.

The actuators shown FIGS. 8d(i) and 8d(ii) are identical to those shown in FIG. 8c(i) and 8c(ii) except a heating element 122 has been placed in thermal contact with the opposite metal surface of the bimetal material of the compensator limb 117. This arrangement facilitates powered deflection in the opposite sense to that provided by the actuators heretofore to produce a faster response time when switching from full ON to full OFF.

The advantage in providing an actuator of this nature, as illustrated also in FIG. 8d(iii), is that rather than waiting until the temperature of the active limb has dropped to allow the actuator armature or lifting surface to revert naturally to its undeflected position, an opposite deflection force is applied by energising the heating element 112 on the or each compensator limb 117 to force more rapid response.

As before, it will be appreciated that the bimetal actuators disclosed in FIGS. 8a to 8d may be substituted using piezo-electric actuator with the necessary modifications to the actuator armatures to ensure comparable or improved control characteristics.

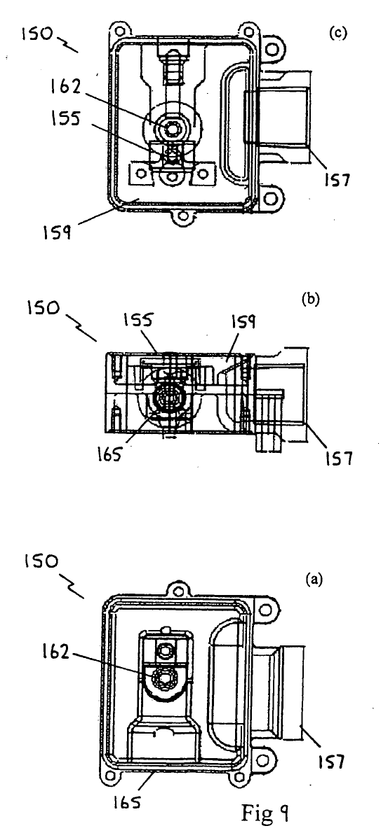

FIG. 9a to 9c show a valve housing 150 in which a valve mechanism 155 in accordance with the preferred construction of the invention is mounted. The housing comprises an inlet coupling 157 for connecting to a gas supply and a top pressure enclosure 159 in which the valve mechanism 155 is mounted to seal a valve seat 162 which defines the orifice leading to the outlet coupling 165 which is connected to the appliance or apparatus for which a regulated gas flow is required.

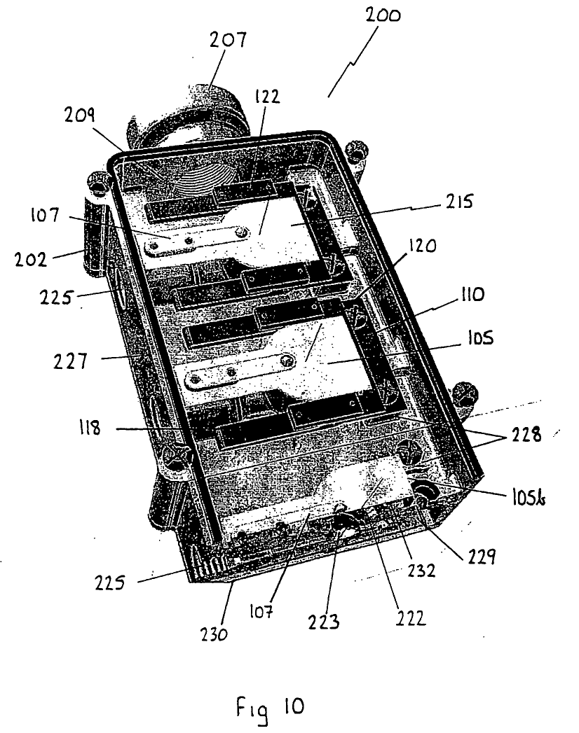

Finally, with reference to FIG. 10, a multi-port valve assembly 200 is shown. This arrangement illustrates the relative simplicity of design of a multi-port valve utilising, in this case, four independently operable valve mechanisms of the present invention. As before, the assembly comprises a housing 202 having an inlet coupling 207 for feeding gas into a top pressure enclosure 209 (shown without cover, for clarity) in which the valve mechanisms 215 are mounted. The valve mechanisms 215 each comprise an actuator 110, of a type similar to that illustrated in FIG. 8a or its piezo-electric equivalent, for example, to operate a sealing element or blade 105 which regulates gas flow through the valve seat defined by the orifice 222 of an outlet channel 223. Each outlet channel 223 leads to an outlet coupling 225 in the side wall 227 of the housing 202. The housing is either cast with a metal or metal alloy or alternatively is moulded in a suitable plastics material (where safety regulations allow). The valve mechanisms, whether identical or otherwise, are mounted via a connecting block 228 to the housing. Electrical connections to actuators 110 may be made to an unpressurised bottom enclosure 229 of the housing to allow for easy connection to power control circuitry and covers 230 secured to define the enclosures 209,229.

It will be seen from FIG. 10 that at the orifice 222 of the through-flow channel 223, the valve seat is further defined by an O-ring seal 232. It will also be seen that the biasing spring 107 of the valve mechanism 215 abuts the blade 105 at a position which is coincident with the orifice 222. As will be described in more detail below, the point of contact is approximately 1 mm inside the radius of the O-ring 232. Thus, as the lifting surface 120 of the actuator 110 is deflected upwardly, the free edge 105b of the blade is elevated and, against the bias of the spring 107, is peeled back from its illustrated position to break the seal using minimal lifting force. In the most preferred embodiment of the valve mechanism, the blade has the profile shown in FIG. 6a and has a separate flexible film layer as described above with reference to FIGS. 7a to 7d.

With a stiffer blade, the lifting force of the actuator may be limited and the maximum sealing force would be correspondingly less. While an adequate seal may be established in the forward flow direction, some applications (and/or regulations) require the valve to withstand pressure in the reverse direction while maintaining the seal. A test of the quality or “hardiness” of the valve is often required by such standards authorities or regulatory bodies who are responsible for approving the use of a valve in domestic and commercial applications. With a stiffer blade, a 60 g sealing force could not be used to maintain a seal under a reverse pressure test.

With the flexible blade and the peeling motion to break the established seal, a sealing force of upwards of 600 g may be applied but requiring only an activator lifting force of say 60 g to peel back the free end of the blade and break the seal. This mechanical advantage may be exploited to allow a significant amount of design freedom and/or variation in manufacturing tolerances. With a target sealing force of 260 g equivalent weight, the compressive force applied to the O-ring is relatively small although it compensates for certain design imperfections. Ideally, the O-ring should be compressed by at least 75 microns (0.075 mm) but, as shown graphically below, the available compressive load at 260 g is between 2 and 4 microns (0.002 and 0.004 mm).

[image]

Using a downforce datum position, that is, where the biasing spring acts on the blade in relation to the valve seat O-ring, of 1 mm inside the internal radius of the O-ring, a test of leak rates through the seal under different conditions was conducted. The test was also conducted to account for misalignment of the biasing spring to establish the effect of manufacturing or assembly imperfections.

The test results, which are tabulated below, establish the effect of the application of grease to the O-ring under different sealing forces.

Effect of Grease on Sealing properties of 0.1 mm Blade

| | | Leak Rate (l/min) @ 20 mBar with indicated downforce | | | | | |
|---|---|---|---|---|---|---|---|
| | 0.1 mm | | | | | 60 g | 260 g |
| O-Ring | Reed | | | 60 g | 260 g | Both sides of | Both sides of |
| Sample | Sample | 60 g | 260 g | Btm of O-Ring | Btm of O-Ring | O-Ring | O-Ring |
| No. | No. | No Grease | No Grease | Greased | Greased | Greased | Greased |
| 1 | 1 | <0.2 | <0.2 | 0.26 | <0.20 | 0.00 | 0.00 |
| | 2 | <0.2 | <0.2 | 0.25 | 0.23 | 0.00 | 0.00 |
| | 3 | 1.35 | 1.30 | 1.25 | 1.14 | 0.00 | 0.00 |
| | 4 | 0.40 | 0.36 | 0.31 | 0.29 | 0.00 | 0.00 |
| | 5 | 0.30 | 0.27 | 0.20 | <0.20 | 0.00 | 0.00 |
| 2 | 1 | 0.27 | 0.24 | 0.30 | 0.27 | 0.00 | 0.00 |
| | 2 | 0.45 | 0.43 | 0.30 | 0.26 | 0.00 | 0.00 |
| | 3 | 1.70 | 1.37 | 1.60 | 1.50 | 0.00 | 0.00 |
| | 4 | 0.30 | 0.30 | 0.46 | 0.43 | 0.00 | 0.00 |
| | 5 | <0.2 | <0.2 | 0.51 | 0.48 | 0.00 | 0.00 |
| 3 | 1 | <0.2 | <0.2 | <0.20 | <0.20 | 0.00 | 0.00 |
| | 2 | <0.2 | <0.2 | <0.20 | <0.20 | 0.00 | 0.00 |
| | 3 | 1.13 | 1.05 | 0.68 | 0.65 | 0.00 | 0.00 |
| | 4 | 0.45 | 0.44 | <0.20 | <0.20 | 0.00 | 0.00 |
| | 5 | 0.30 | 0.30 | <0.20 | <0.20 | 0.00 | 0.00 |
| 4 | 1 | 0.23 | <0.20 | <0.20 | <0.20 | 0.00 | 0.00 |
| | 2 | <0.2 | <0.20 | <0.20 | <0.20 | 0.00 | 0.00 |
| | 3 | 0.75 | 0.60 | 1.20 | 1.15 | 0.00 | 0.00 |
| | 4 | <0.2 | <0.20 | <0.20 | <0.20 | 0.00 | 0.00 |
| | 5 | 0.36 | 0.34 | <0.20 | <0.21 | 0.00 | 0.00 |
| 5 | 1 | <0.2 | <0.20 | <0.20 | <0.22 | 0.00 | 0.00 |
| | 2 | <0.2 | <0.20 | 0.25 | <0.23 | 0.00 | 0.00 |
| | 3 | 1.36 | 1.29 | 1.34 | 1.25 | 0.00 | 0.00 |
| | 4 | 0.26 | 0.23 | 0.31 | 0.31 | 0.00 | 0.00 |
| | 5 | 0.32 | 0.32 | 0.33 | 0.31 | 0.00 | 0.00 |

The tests yielded encouraging results, however, after several opening and closing cycles, the grease tends to migrate and the sealing efficiency is dropped. Although it was found that a highly polished blade surface would maintain a good seal, this was found to be expensive and susceptible to failure through contamination and minor scratches.

The optimum solution as described in detail hereinabove is to use a separate pliable plastics material film which has a smooth surface finish. The metal blade provides fire protection (which would destroy the plastics film) by forming a sufficiently coherent seal in the event the film fails. The metal blade also acts to spread the sealing force from the spring substantially evenly around the O-ring. Furthermore, the centre of the film can be depressed or may be drawn down below the top of the O-ring (typically by up to 1.5 mm) and wrap over the upper and inner surface of the O-ring increasing the contact area beyond that obtained by the blade alone. The effectiveness of the seal is related to the contact area of the seal and, in this case, the contact area using the pliable film is in the region of twice that obtained using a blade. The pliable film is also better able to cope with assembly variances that may offset the downforce contact point of the biasing spring. The film more easily adopts the convolute concave shapes that are demanded of it when the contact point is away from the centre of the O-ring. Therefore, the film obviates the requirement for an expensive highly polished blade which, to perform optimally, would need to be of a complex shape and positioned with a high degree of accuracy.

The description hereinabove demonstrates the function of the valve mechanism and multi-port valve with respect to domestic gas and the control there of for gas-fired central heating boilers, gas fires and cookers. However, it will be appreciated by the skilled addressee that the applications of the valve mechanism and multi-port valve are not so limited and that beyond industrial gas use there are occasions where measured amounts of gas might be needed. An electronically controllable valve could be used for timed release of anaesthetic or pain relieving gases in a medical or veterinary environment.

It will of course be understood that the invention is not limited to the specific details described herein, which are given by way of example only, and that various modifications and alterations are possible within the scope of the appended claims.

1. A method of opening a valve seal using minimal operational force, the method comprising:
forming a seal using a cantilevered blade, thereby defining a leading or distal edge;
engaging the distal edge to “peel” back a portion of the blade to break an established seal; and thereafter
moving the blade in accordance with required flow control parameters.

2. A multi-port valve having an integrally formed valve body comprising a plurality of through-flow orifices each being provided with independently actuable valve opening means, each of said means comprising an actuator which is operably connected to an orifice sealing element in such a way as to lift a free edge of the sealing element to break an established seal.

3. A multi-port valve as claimed in claim 2 in which, the actuator includes a bimetal element which is deflectable by energising a heating element attached thereto.

4. A multi-port valve as claimed in claim 2 in which, the actuator comprises a piezo-electric element which is connected to and deflectable by an energising circuit.

5. A multi-port valve as claimed in claim 2 in which, the flow characteristic of each valve of the multi-port valve is not the same.

6. A multi-port valve as claimed in claim 2 in which, a pair of orifice sealing elements comprise a two-port valve, both sealing elements being operably coupled to a single valve opening actuator.

7. A multi-port valve as claimed in claim 2 in which, the valve body comprises at least two castings, the first casting comprising an inlet manifold defining a series of side-by-side through-flow orifices connecting a single inlet port to the multiple outlet ports and the second casting comprising a lid to define sealingly said inlet manifold.

8. A multi-port valve as claimed in claim 7 in which, the first casting includes anchor points for the valve opening means.

9. An actuator driven fluid flow valve comprising:
an actuator housing;
an actuator element mounted within the housing and adapted to deflect when energised;
an actuator armature operably comprising a valve opening means; and
a through-flow orifice defined between a supply inlet port and an outlet port, all formed within a second housing attached to the actuator housing, adapted to receive the armature driven valve opening means
in which the valve opening means engages the through-flow orifice to effect a releasable seal.

10. An actuator driven fluid flow valve as claimed in claim 9 in which, the actuator armature is coupled to a valve mechanism having a sealing element normally held in sealing connection to the through-flow orifice.

11. An actuator driven fluid flow valve as claimed in claim 9 in which, the fluid valve comprises a butterfly valve having a shaft about which the butterfly valve element rotates, the shaft including a gear means adapted to engage, and operably rotate with the movement of, the actuator armature.

12. An actuator driven fluid flow valve as claimed in claim 9 in which, the fluid valve orifice includes a valve seat which is operably engaged by a valve member attached (directly or indirectly) to the actuator armature so that, when the actuator element is deflected, the valve member lifts from the valve seat to allow fluid flow through the orifice.

13. An actuator driven fluid flow valve as claimed in claim 9 in which, the fluid valve orifice includes a sealing element which is operably attached (directly or indirectly) to the actuator armature so that, when the actuator element is deflected, a free edge of the sealing means is lifted to break an established seal.

14. An actuator driven valve mechanism, suitable for use with fluid valves of the type used for controlling the fluid flow of combustible and/or hazardous liquid and gaseous media, having a supply inlet port and at least one outlet port and defining therebetween a through-flow orifice, the valve mechanism comprising a sealing element, the element being held in sealing connection with the orifice by a biasing means against which a valve opening means acts, the valve opening means comprising an actuator armature which is operably connected to the sealing element in such a way as to lift a free edge of the sealing element to break an established seal.

15. An actuator driven valve mechanism as claimed in claim 14 in which, the biasing means acts directly on the actuator armature, the movement of which is governed by the deflection of an actuator element which is deflected when energised.

16. An actuator driven valve mechanism as claimed in claim 14 in which, the sealing means comprises a flexible blade held in cantilever arrangement and resting across the orifice.

17. An actuator driven valve mechanism as claimed in claim 14 in which, the actuator armature operably “peels back” the sealing element from engagement with the orifice to break the established seal.

18. An actuator driven valve mechanism as claimed in claim 14 in which, the sealing means is in the form of a thin blade adapted to form a gas-tight seal against the orifice under the force of the biasing means.

19. An actuator driven valve mechanism as claimed in claim 18 in which, the blade is metal and has a finish which is sufficiently smooth to form at least a substantially gas-tight seal.

20. An actuator driven valve mechanism as claimed in claim 18 in which, a plastics material layer or film may be applied to one side of the blade to provide the requisite finish.

21. An actuator driven valve mechanism as claimed in claim 18 in which, the blade comprises a first metal blade and a second plastics material blade having a finish which assures a gas-tight seal.

22. An actuator driven valve mechanism as claimed in claim 21 in which, the blade arrangement is such that the plastics material blade may be a thin film.

23. An actuator driven valve mechanism as claimed in claim 18 in which, the blade comprises a plastics material onto which there is applied, conveniently by sputtering, a metal layer which could close the seal sufficiently to prevent failure of the valve in case of fire.

24. An actuator driven valve mechanism as claimed in claim 14 in which, the biasing means is placed in contact with the sealing means which comprises a blade which is distorted by the biasing means so that a concave shape is imparted on the blade which “dips” into the orifice of the valve.

25. An actuator driven valve mechanism as claimed in claim 14 in which, the orifice has a sealing O-ring or similar distortable sealing element around the mouth thereof.

26. An actuator driven valve mechanism as claimed in claim 21 in which, the plastics material blade is separate from the metal blade so that the plastics material blade may be further drawn (“dipped”) into the orifice creating a high quality seal of greater sealing contact area than mere face-to-face contact.

27. An actuator driven valve mechanism as claimed in claim 14 in which, the actuator armature is disposed in operable connection to the leading edge of at least one blade so that on powered deflection of the actuator element, the leading edge is peeled back from sealing connection with the orifice, thereby breaking the seal.

28. An actuator driven energy regulator comprising:
an actuator housing;
an actuator element mounted within the housing and adapted to deflect when energised;
an actuator armature operable to actuate a switch or control means for an auxiliary control parameter; and
a switch or control means mounted within a second housing attached to the actuator housing and adapted to receive the actuator armature.

29. An actuator driven energy regulator as claimed in claim 28 in which, the control means comprises a rheostat or potentiometer for regulating said auxiliary control parameter.

30. An actuator driven energy regulator as claimed in claim 28 in which, a switch is operably mounted within the actuator housing.

31. An actuator driven energy regulator as claimed in claim 28 in which, armature guides are provided in the or each housing to constrain the armature movement along a linear path.

32. An actuator driven energy regulator as claimed in claim 31 in which, the or each guide includes a sealing means to ensure the actuator energising, switching or control means function is isolated from the surrounding atmosphere.

33. An actuator driven energy regulator as claimed in claim 28 in which, the armature moves linearly with respect to the housing by an amount which is substantially proportional to the change in power applied to energise the actuator element.

34. An actuator mechanism comprising a bimetal element having a heating element mounted thereon, the bimetal element being deflectable by energising the heating element to effect thermal transfer of the bimetal element, the degree of deflection being related substantially to the power applied to energise the heating element, the deflection causing an actuator armature to move along a defined path against a biasing means adapted to return the armature to its non-deflected position.

35. An actuator mechanism as claimed in claim 34 in which, the bimetal element comprises an active portion and a compensator portion for compensating for the effects of ambient temperature fluctuations.

36. An actuator mechanism as claimed in claim 35 in which, the active portion comprises a deflector limb adapted to engage the actuator armature to effect movement thereof.

37. An actuator mechanism as claimed in claim 34 in which, the bimetal element comprises an active portion responsive to the heating element mounted thereon and a compensator portion for compensating for the effects of ambient temperature fluctuations, wherein the active and compensator portions are formed of the same piece of bimetal and the bimetal element is secured at one end within an actuator housing.

38. An actuator mechanism as claimed in claim 34 in which, the active portion includes an adjustment means.

39. An actuator mechanism as claimed in claim 38 in which, the adjustment means facilitates the matching of the movement of the actuator armature to the movement required to utilise the range of a controller, regulator or valve to which the actuator is attached.

40. An actuator mechanism as claimed in claim 37 in which, the active portion of the bimetal element and the compensator portion are integral and may be formed by splitting a bimetal strip lengthways from one end along a part of its length.

41. An actuator mechanism as claimed in claim 40 in which, the bimetal strip is secured at its split end.

42. An actuator mechanism as claimed in claim 34 in which, the bimetal element is shaped or laser-cut and formed into the required three-dimensional shape.

43. An actuator mechanism or an actuator driven control device having an actuator mechanism as claimed in claim 14, in which there is provided a bimetal element having disposed thereon at least two heating elements adapted to deflect the bimetal element in opposite directions.

44. An actuator mechanism or an actuator driven control device as claimed in claim 43 in which, a first heating element is disposed on an active portion of the bimetal element to move the bimetal element or an actuator armature towards a deflected position and a second heating element is disposed on a compensation portion of the bimetal element to drive the bimetal element or armature towards a non-deflected position, thereby increasing the response time thereof.

45. An actuator mechanism comprising a piezo-electric element having an energising circuit connected thereto, the piezo-electric element being deflectable by electrically stimulating the piezo-ceramic material of the element, the degree of deflection being related substantially to the power applied to energise the element, the deflection causing an actuator armature to move along a defined path against a biasing means adapted to return the armature to its non-deflected position.

46. An actuator mechanism as claimed in claim 45 in which, the piezo-electric element comprises a deflector limb adapted to engage the actuator armature to effect movement thereof.

47. An actuator mechanism as claimed in claim 45 in which, the energising circuit includes control circuitry adapted to compensate for effects of ambient temperature fluctuation and includes set-point adjustment means.

48. An actuator mechanism as claimed in claim 47 in which, the adjustment means facilitates the matching of the movement of the actuator armature to the movement required to utilise the range of a controller, regulator or valve to which the actuator is attached.

49. An actuator mechanism or actuator driven control device having an actuator mechanism as claimed in claim 14, in which there is provided a piezo-electric element connected to an energising circuit capable of deflecting an actuator armature in opposite directions.
